(19) United States
(12) Patent Application Publication
(10) Pub. No.: US 2022/0364419 A1
(43) Pub. Date: Nov. 17, 2022

(54) LAMINATED MAGNETIC CORES FOR A WIRELESS COUPLER IN A WELLBORE

(71) Applicant: Halliburton Energy Services, Inc., Houston, TX (US)

(72) Inventors: Joachim Pihl, Sandefjord (NO); Harald Wittersø, Larvik (NO)

(21) Appl. No.: 17/317,214

(22) Filed: May 11, 2021

(51) Int. Cl. E21B 17/02; E21B 47/13

(52) U.S. Cl. CPC E21B 17/0283; E21B 47/13; G01V 3/28

(57) ABSTRACT

A system can include a first wireless coupler and a second wireless coupler. The first wireless coupler can include a first laminated core that can be wrapped around a tubular and a first wire wrapped around the first laminated core. The second wireless coupler can include a second wire that can be positioned coaxially around the first wire and at a distance from the first wire for facilitating wireless power transfer between the first wireless coupler and the second wireless coupler. The second wireless coupler may or may not include a second laminated core wrapped around the second wire.

### TECHNICAL FIELD

The present disclosure relates generally to wireless power and data transfer in a wellbore and, more particularly (although not necessarily exclusively), to wireless couplers with laminated magnetic cores usable to transfer power and data between downhole components in a wellbore.

### BACKGROUND

Downhole tools may be positioned in a wellbore formed through a subterranean formation to perform wellbore operations, such as drilling, completion, and production operations. Multiple downhole tools may be mechanically interconnected downhole to perform the wellbore operations. Power can be transmitted from the well surface to the downhole tools using power transmission equipment, such as cables. In some cases, power transfer between downhole tools may be performed wirelessly. But, such wireless power transfer can be inefficient due to eddy currents and other power loss mechanisms.

### BRIEF DESCRIPTION OF THE DRAWINGS

FIG. 1 shows a cross-sectional view of a well system that includes a wellbore with wireless couplers that include laminated magnetic cores according to some examples of the present disclosure.

FIG. 2 shows a cross-sectional side-view of wireless couplers with laminated magnetic cores according to some examples of the present disclosure.

FIG. 3 shows a perspective view of an example of a magnetic core according to some examples of the present disclosure.

FIG. 4 shows a cross-sectional side-view of an example of a magnetic core according to some examples of the present disclosure.

FIG. 5 shows a perspective view of an example of a wireless coupler according to some examples of the present disclosure.

FIG. 6 shows a cross-sectional side-view of an example of a wireless coupler according to some examples of the present disclosure.

FIG. 7 shows a cross-sectional end-view of a portion of a laminated magnetic core with laminated layers oriented in a direction that is parallel to a longitudinal axis according to some examples of the present disclosure.

FIG. 8 shows a top-view of a stacked laminated magnetic core according to some examples of the present disclosure.

FIG. 9 shows a perspective view of a stacked laminated magnetic core according to some examples of the present disclosure.

FIG. 10 shows a close-up cross-sectional side view of a portion of a wireless coupler that includes an insulation layer according to some examples of the present disclosure.

FIG. 11 shows a flow chart of a process for using wireless couplers in a wellbore according to some examples of the present disclosure.

FIG. 12 shows a flow chart of a process for forming a magnetic core using sheets of magnetically permeable material according to some examples of the present disclosure

FIG. 13 shows a flow chart of a process for forming a magnetic core using hollow bars according to some examples of the present disclosure.

FIG. 14 shows a completion stage of a well that includes wireless couplers according to some examples of the present disclosure.

### DETAILED DESCRIPTION

Certain aspects and examples of the present disclosure relate to well tools with wireless couplers that include laminated magnetic cores designed to reduce eddy currents and improve wireless power and data transfer efficiency between the well tools. A laminated magnetic core can be a magnetic core that is created through a lamination process in which layers of material are disposed on top of one another. Each wireless coupler can include a laminated magnetic core with a wire positioned on (e.g., wrapped around) the laminated magnetic core. Each wireless coupler may also include a tubular for structural support. The tubular can have a cylindrical shape, a bobbin shape, or any other suitable shape.

The laminated magnetic cores can improve power transfer and data transfer efficiency by reducing or eliminating eddy currents. Power transferred across a magnetic core that is not laminated can induce a magnetic field, which can induce an eddy current that flows around the magnetic core. The laminated magnetic core can reduce or eliminate the induced eddy current by using insulating or otherwise non-conducting material that is positioned along a path of potential eddy currents, which can be around an exterior surface of the laminated magnetic core. Eddy currents can cause magnetic cores to increase in temperature during power transfer or data transfer. The increased temperature can cause excess heat to be given off by magnetic cores, which can cause power loss, data loss, or a combination thereof associated with the increased temperature. Accordingly, power transfer efficiency and data transfer efficiency can be improved by reducing or eliminating eddy currents. Additionally, the laminated magnetic core can have improved structural integrity over other magnetic cores. For example, eddy currents can heat the other magnetic cores enough to crack or to otherwise cause damage to the other magnetic cores. The laminated magnetic cores, due to the reduced or eliminated eddy currents, may not heat up and consequently may not crack or encounter other structural issues like the other magnetic cores.

In some examples, the wireless couplers can be positioned in spatial proximity to one another in the wellbore for engaging in wireless power and data transfer. For example, a first well tool can include a first wireless coupler and a second well tool can include a second wireless coupler. The first well tool can be positioned downhole at a first point in time and the second well tool can be positioned downhole at a second point in time, which may be different than the first point in time. The second wireless coupler can be positioned coaxially with respect to the first wireless coupler, for example such that the second wireless coupler is internal to the first wireless coupler and in close physical proximity to the first wireless coupler, with a spatial gap (e.g., an air gap) between the first wireless coupler and the second wireless coupler. This spatial relationship may allow the wireless couplers to engage in wireless power and data transmission in the wellbore, so that power and data can be transferred between the well tools.

The wireless couplers can include magnetic cores for improving functional or power efficiency, particularly in the presence of conductive materials that are common in downhole environments. But, some magnetic cores can present problems. For example, magnetically permeable materials that are suitable for use in such magnetic cores, such as magnetically permeable materials that are not electrically conductive and that can withstand the downhole environment, may be difficult to access and use. For example, ceramic materials like ferrites and pressed iron powder cores may have walls that can become undesirably thin and brittle if scaled down to comply with space constraints in a downhole environment such as a wellbore. Additionally, the ceramic materials may be expensive and/or difficult to manufacture.

Some magnetic cores can also encounter problems with short circuits and eddy currents. For example, relating to a solenoid arrangement like a downhole wireless coupler, materials close to windings of the solenoid and between the windings of the solenoid can cause one or more short-circuits if the materials form a closed electrical path around a rotational axis of the solenoid. In such examples, the materials can form a parasitic winding in the solenoid that may reduce efficiency or effectiveness of the solenoid. In some examples, a soft steel core can function as a core material to amplify magnetic flux and can be easy to manufacture. But, due to the soft steel core forming a short circuited winding, it may additionally rob power from the solenoid. Including one or more slits longitudinally in the magnetic core of the solenoid can improve performance of the solenoid, but circular current paths, or eddy currents, in a face plane of cylindrical pieces of the solenoid can reduce efficiency of the solenoid and can prevent an optimized performance of the solenoid.

To prevent formation of parasitic conductive paths, and to allow use of easily-accessible materials, some examples of the present disclosure can involve wireless couplers that have laminated magnetic cores. For example, the wireless couplers can include a thin-walled, bobbin-shaped magnetic core. The magnetic core can include laminated silicon steel or one or more amorphous iron sheets with resin and, in some examples, fiber-matting to produce a durable and dimensionally stable bobbin core and coil assembly. The thin-walled, bobbin-shaped magnetic core can include improved electro-magnetic performance compared to other approaches, such as laminating together sheets of soft silicon steel that are coated with a non-conductive coating. The laminated magnetic core can prevent core conductivity of the wireless coupler in more than one plane to prevent eddy currents. Additionally, high permeability material can be extended parallel to an axis of rotational symmetry for the magnetic core.

Various manufacturing techniques can be used to create the laminated magnetic cores. For example, cut sheets of magnetically permeable material, which can include annealed silicon steel sheets or other suitable materials, can be used to form the magnetic core. The cut sheets can be low-cost and can be an easily accessed material. In some examples, layers of steel and fiber can be stacked, clamped, and/or cast in a vacuum-cast process. Alternatively, sheets of steel can be stamped or cut to a rough shape and arranged in a radial pattern in a mold. The arrangement can include fibers between the stamped steel. The resulting core may be free from patches of surface conductivity in a tangential direction. The resulting rough shape can be machined to a final form by boring, milling, and/or turning. The resulting shape can improve power efficiency compared to other designs. In some examples, the sheets of magnetically permeable material can be stacked in a radial plane of the finished bobbin. Sheets of the material can be split in order to prevent a continuous ring from forming. To improve mechanical stability, the split can be moved or rotated for each layer.

In another exemplary manufacturing process, a hollow bar, or cylinder, of a magnetically permeable material can be used. The cylinder can be formed into a bobbin shape using subtractive processes such as turning and milling. Slits can be cut in a radial direction in the cylinder to inside a final inner diameter of the finished bobbin. In some examples, the slits can be cut using a wire electrical discharge machine for making the slits straight and narrow. The slits can be filled with resin in a vacuum cast or other suitable process. Additionally, the slits can be cured and machined or turned before curing to desired dimensions in which fins of the slits can be disconnected from each other.

The above illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

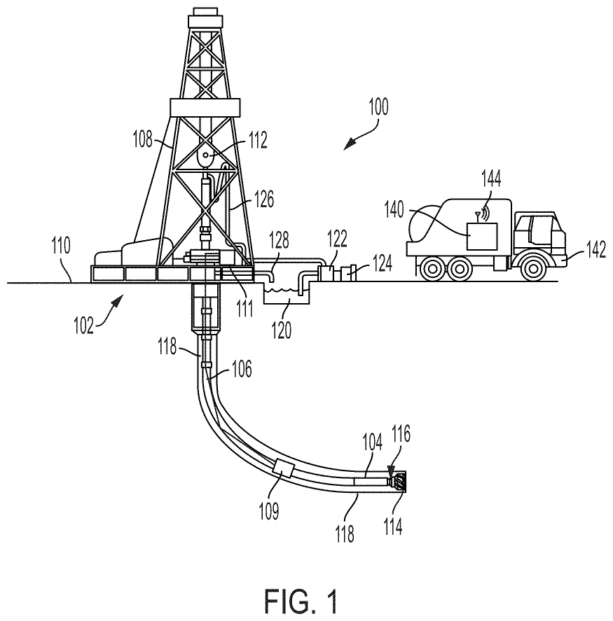

FIG. 1 is a cross-sectional view of a well system 100 that includes a wellbore 118 with wireless couplers 109 positioned downhole that include laminated magnetic cores according to some examples of the present disclosure. As illustrated, the well system 100 includes components for performing drilling operations for forming the wellbore 118, but the well system 100 can alternatively be configured to perform wellbore operations such as completion operations, production operations, and other suitable wellbore operations. The wellbore 118 can be used to extract hydrocarbons from a subterranean formation 102. The wellbore 118 can be drilled or otherwise formed using the well system 100. The well system 100 may drive a bottom hole assembly (BHA) 104 positioned or otherwise arranged at the bottom of a drill-string 106 extended into the subterranean formation 102 from a derrick 108 arranged at the surface 110. The derrick 108 can include a kelly 112 used to lower and raise the drill-string 106.

The BHA 104 may include a drill bit 114 operatively coupled to a tool string 116, which may be moved axially within a drilled wellbore 118 as attached to the drill-string 106. The tool string 116 may include one or more wireless couplers 109 for transmitting power and data in the wellbore 118. The wireless couplers 109 may transmit power and data in the wellbore, for example longitudinally or between interconnected subparts of the tool string 116, for allowing the subparts to perform wellbore operations.

During operation, the drill bit 114 penetrates the subterranean formation 102 to create the wellbore 118. The BHA 104 can control the drill bit 114 as the drill bit 114 advances into the subterranean formation 102. The combination of the BHA 104 and the drill bit 114 can be referred to as a drilling tool. Fluid or “mud” from a mud tank 120 may be pumped downhole using a mud pump 122 powered by an adjacent power source, such as a prime mover or motor 124. The mud may be pumped from the mud tank 120, through a stand pipe 126, which feeds the mud into the drill-string 106 and conveys the mud to the drill bit 114. The mud exits one or more nozzles (not shown) arranged in the drill bit 114 and thereby cools the drill bit 114. After exiting the drill bit 114, the mud circulates back to the surface 110 via the annulus defined between the wellbore 118 and the drill-string 106, thereby carrying the drill cuttings and debris to the surface. The cuttings and mud mixture are passed through a flow line 128 and are processed such that a cleaned mud is returned down hole through the stand pipe 126 once again.

A power source 111, such as a battery or a generator, can be positioned at the surface 110 for transferring power into the wellbore 118. The power source 111 can be in electrical connection with the wireless couplers 109 and a computing device 140. The power source 111 can transmit power to one or more subparts or subsystems positioned in the wellbore 118. For example, the power source 111 can transmit power to a first wireless coupler on a first subpart of the tool string 116. The first wireless coupler, in turn, can wirelessly transfer the power to a second wireless coupler on a second subpart of the tool string 116. Using this process, power can be conveyed to the second subpart of the tool string 116 for performing one or more operations downhole.

A computing device 140 can be positioned belowground, aboveground, onsite, in a vehicle 142, offsite, etc. As shown in FIG. 1, the computing device 140 is positioned on the vehicle 142 at the surface 110. The computing device 140 can include a processor interfaced with other hardware via a bus. A memory, which can include any suitable tangible (and non-transitory) computer-readable medium, such as random-access memory (“RAM”), read-only memory (“ROM”), electrically erasable and programmable read-only memory (“EEPROM”), or the like, can embody program components that configure operation of the computing device 140. In some aspects, the computing device 140 can include input/output interface components (e.g., a display, printer, keyboard, touch-sensitive surface, and mouse) and additional storage. The computing device 140 can be communicatively coupled to the wireless coupler 109.

In some examples, the drill-string 106 can include various subparts or subsystems, such as well tools, that can transfer power and data to one another via the wireless couplers 109. Additionally, the subparts or subsystems can be communicatively coupled to the computing device 140 via the wireless couplers 109. For example, a measuring-while-drilling subsystem proximate to the drill bit 114 can transmit data wirelessly across the wireless couplers 109 to another subsystem of the drill string, which in turn can convey the data up-hole to the computing device 140 at the well surface 110 (e.g., via an embedded wire or additional sets of wireless couplers). Additionally or alternatively, the computing device can convey data downhole to a subsystem in the wellbore 118 that can transmit the data wirelessly across the wireless couplers 109 to the measuring-while-drilling subsystem.

The computing device 140 can include a communication device 144. The communication device 144 can represent one or more of any components that facilitate a network connection. In the example shown in FIG. 1, the communication devices 144 are wireless and can include wireless interfaces such as IEEE 802.11, Bluetooth™, or radio interfaces for accessing cellular telephone networks (e.g., transceiver/antenna for accessing a CDMA, GSM, UMTS, or other mobile communications network). In some examples, the communication device 144 can use acoustic waves, surface waves, vibrations, optical waves, or induction (e.g., magnetic induction) for engaging in wireless communications. In other examples, the communication device 144 can be wired and can include interfaces such as Ethernet, USB, IEEE 1394, or a fiber optic interface. In an example with at least one other computing device, the computing device 140 can receive wired or wireless communications from the other computing device and perform one or more tasks based on the communications.

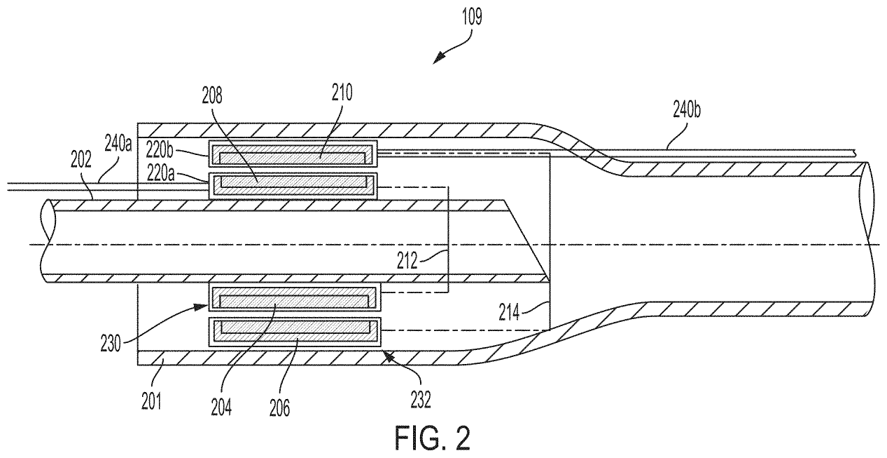

FIG. 2 is a sectional side-view of wireless couplers 109 with laminated magnetic cores according to some examples of the present disclosure. The wireless couplers 109 can be positioned on a first tubular 202, a second tubular 201, a combination thereof, or other suitable mechanism for positioning the wireless couplers 109 in the wellbore 118. In some examples, the first tubular 202 and the second tubular 201 can be mandrels, one or more parts of one or more downhole tools, or other suitable tubular components. A first wireless coupler 230 can be positioned on the first tubular 202, and a second wireless coupler 232 can be positioned on the second tubular 201. The first wireless coupler 230 can be positioned concentrically or eccentrically with respect to the second wireless coupler 232.

The first wireless coupler 230 can include a first magnetic core 204 and a first wire 208, and the second wireless coupler 232 can include a second magnetic core 206 and a second wire 210. In some examples, the first magnetic core 204 can be characterized by a first circumference 212. Although the first circumference 212 is shown in FIG. 2 as being less than an outer circumference of the first wireless coupler 230, in some examples the first circumference 212 can be similar or identical to the outer circumference of the first wireless coupler 230 depending on the shape of the first magnetic core 204. Additionally, the second magnetic core 206 can be characterized by a second circumference 214. Although the second circumference 214 is shown in FIG. 2 as being less than an outer circumference of the second wireless coupler 232, in some examples the second circumference 214 can be similar or identical to the outer circumference of the second wireless coupler 232 depending on the shape of the second magnetic core 206. In these examples, the first circumference 212 can be less than the second circumference 214. The first magnetic core 204 and the second magnetic core 206 can include magnetic material such as steel, other ferrous material, or other suitable magnetic material. The first wire 208 can be positioned on the first circumference 212 and wrapped around the first magnetic core 204. The second wire 210 can be positioned on the second circumference 214 and located radially internally to at least some of the second magnetic core 206. The first wire 208 and the second wire 210 can respectively be wrapped around the first magnetic core 204 and the second magnetic core 206 clockwise, counterclockwise, or in other suitable manners. In some examples, the first magnetic core 204, the second magnetic core 206, or a combination thereof are laminated to reduce magnetic fields or eddy currents in various directions that can be emitted from or otherwise generated by the first wireless coupler 230, the second wireless coupler 232, or a combination thereof.

In some examples, a transmitter can be coupled to the first wire 208 of the first wireless coupler 230 via a first cable 240a, and a receiver can be coupled to the second wire 210 of the second wireless coupler 232 via a second cable 240b. The transmitter can transmit data to the receiver via a wireless connection between the wireless couplers 230, 232. In examples in which the first wireless coupler 230 and the second wireless coupler 232 are positioned in the wellbore 118, the data can include data about downhole conditions, data about wellbore operations, and other suitable data relating to the wellbore 118.

As noted above, the first wireless coupler 230 can be coupled to a first cable 240a and the second wireless coupler 232 can be coupled to a second cable 240b. The first cable 240a can be internal and/or external to first tubular 202 and the second cable 240b can be internal and/or external to the second tubular 201. The first cable 240a can communicatively and/or electrically couple the first wireless coupler 230 to other components, such as a transmitter, a power source (e.g., an AC power souce), or a computing device 140. These components may be located at the surface of the wellbore 118 or located downhole, such as in a portion of the drill-string 106. The second cable 240b can communicatively and/or electrically couple the second wireless coupler 232 to a well tool, or other suitable component, positioned further downhole with respect to the second wireless coupler 232.

In some examples, the first wireless coupler 230 and the second wireless coupler 232 can include environmental shielding 220a-b. As illustrated, the first wireless coupler 230 includes environmental shielding 220a and the second wireless coupler 232 includes environmental shielding 220b. The environmental shielding 220a-b can shield against heat, pressure, physical impacts, a combination thereof, or other hazards due to downhole conditions. The environmental shielding 220a can be positioned around the first wireless coupler 230 for shielding the first magnetic core 204 and the first wire 208. The environmental shielding 220b can be positioned around the second wireless coupler 232 for shielding the second magnetic core 206 and the second wire 210. The environmental shielding 220 can include non-conductive or otherwise insulating material such as a polymeric or rubber material.

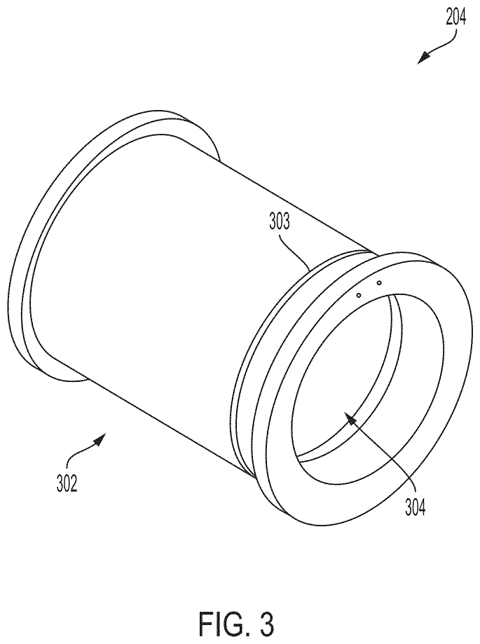

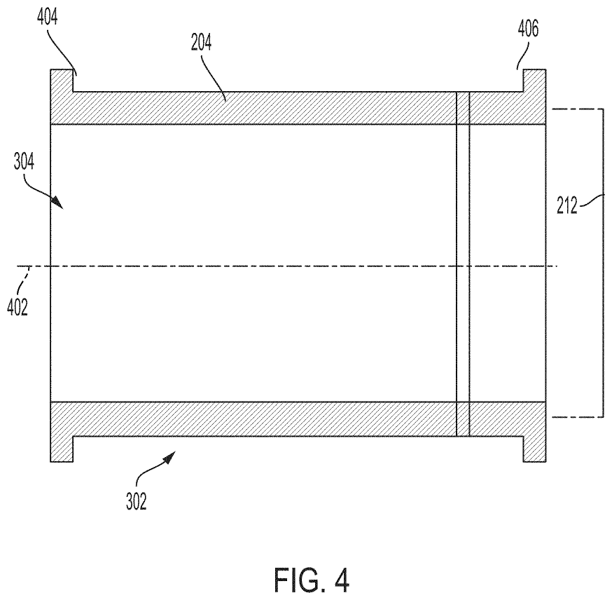

FIG. 3 is a perspective view of a magnetic core 204, and FIG. 4 is a cross-sectional side-view of the magnetic core 204 according to some examples of the present disclosure. In some examples, the magnetic core 204 can be the first magnetic core 204 described with respect to FIG. 2. The magnetic core 204 is illustrated subsequent to a machining process that formed the magnetic core 204 into a bobbin shape. The magnetic core 204 can alternatively be cylindrical or another suitable shape for the magnetic core 204. The magnetic core 204 can be laminated in a direction 303 that is parallel or perpendicular to its longitudinal axis (e.g., longitudinal axis 402 of FIG. 4). The magnetic core 204 can have a recessed portion 302 for receiving a wire coil. Referring now to FIG. 4, the magnetic core 204 may additionally include a longitudinal axis 402 that extends through an interior region 304 of the magnetic core 204. The magnetic core 204 can be characterized by the first circumference 212. The first wire 208 can be wrapped around the magnetic core 204 in a circumferential direction. The first wire 208 can extend from a first side 404 of the magnetic core 204 to a second side 406 of the magnetic core 204. In some examples, the first wire 208 can be coupled to a power source and/or a transmitter to wirelessly transmit power and data, respectively, via the magnetic core 204.

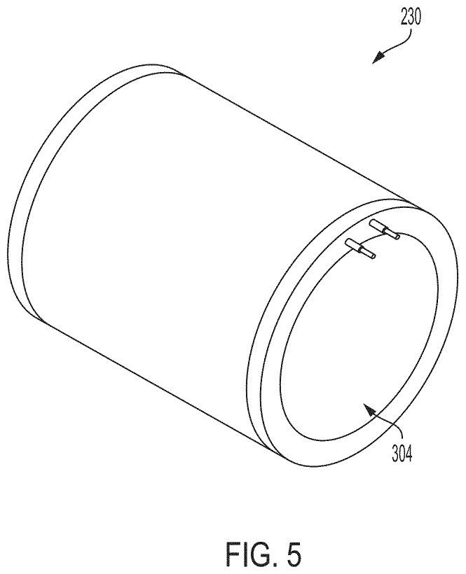

FIG. 5 is a perspective view of a wireless coupler 230 according to some examples of the present disclosure. The wireless coupler 230 is illustrated as the first wireless coupler 230 that is described with respect to FIG. 2. The wireless coupler 230 can have a cylindrical shape or a bobbin shape. The wireless coupler 230 can have an interior region 304 through which a tubular, such as a mandrel or other well component, can be positioned.

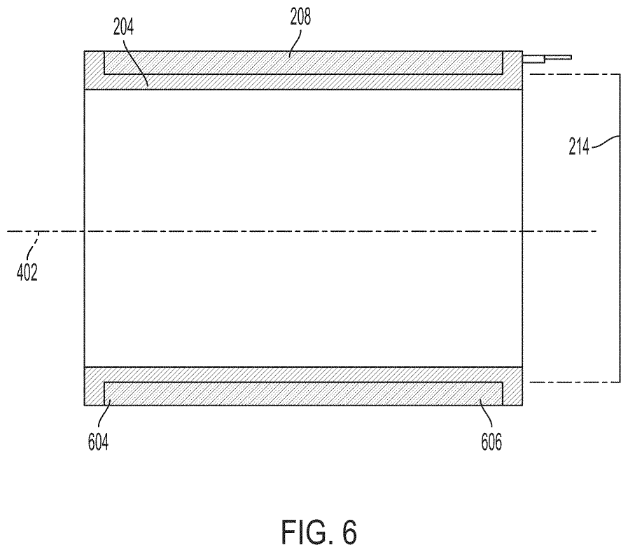

Referring now to FIG. 6, the wireless coupler 230 may additionally include a longitudinal axis 402 that extends through the interior region 304 of the wireless coupler 230. The wireless coupler 230 can include the first magnetic core 204. The first wire 208 can be wrapped around the wireless coupler 230 and around the first magnetic core 204 in a circumferential direction in which a radius of the first wire 208 can be equal to or approximately equal to a radius that extends from the longitudinal axis 602 to the first circumference 212. The first magnetic core 204 and the first wire 208 can extend from a first side 604 of the wireless coupler 230 to a second side 606 of the wireless coupler 230. In some examples, the wireless coupler 230 can be coupled to a transmitter or to a receiver that can allow power and data to be transmitted across the wireless coupler 230.

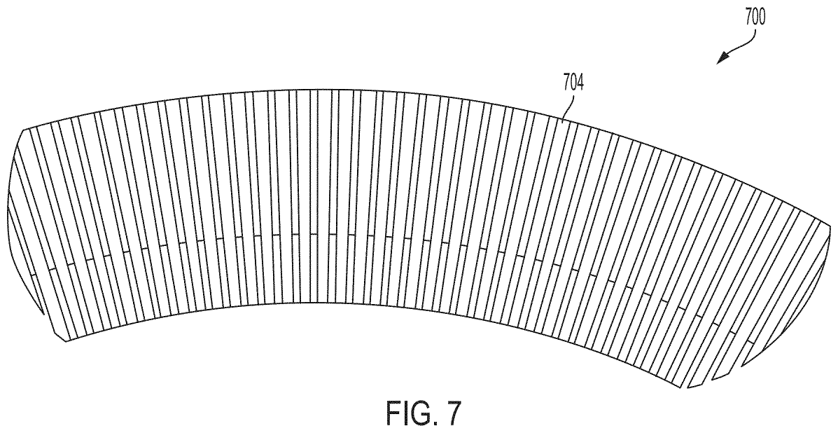

FIG. 7 is a cross-sectional end-view of a portion of a laminated magnetic core 700, such as the first magnetic core 204 of FIG. 6, in which the laminated layers are oriented in a direction that is parallel to the longitudinal axis 402 according to some examples of the present disclosure. In this example, the longitudinal axis 402 would extend out of the page (normal to the page).

The laminated magnetic core 700 can be included in a wireless coupler, such as the first magnetic core 204 or the second magnetic core 206. The laminated magnetic core 700 can include a set of laminated layers 704. The laminated layers 704 can include materials such as ferrous materials or other suitable magnetic materials. In some examples, the laminated layers 704 can be formed from annealed iron sheets. Each laminated layer of the laminated layers 704 can be coupled together to form the laminated magnetic core 700 and to be oriented parallel to the longitudinal axis 402.

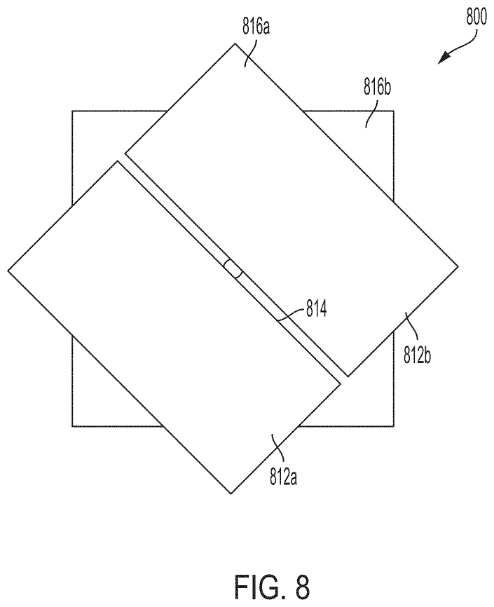

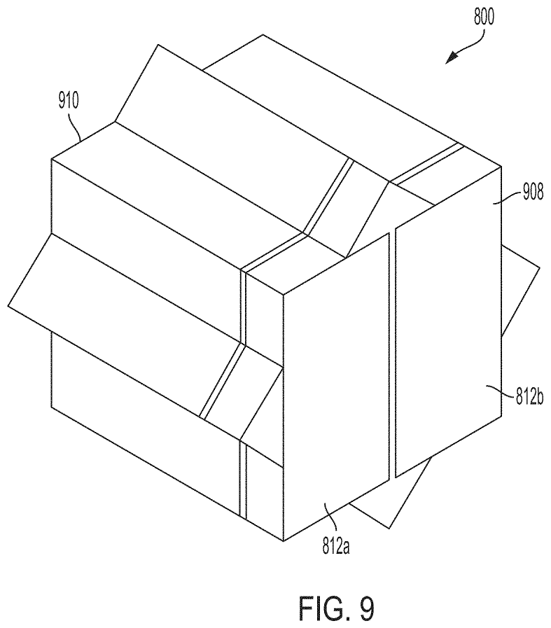

FIG. 8 is a top-view of a stacked laminated magnetic core 800 according to some examples of the present disclosure. The laminated magnetic core 800 can be formed with, or otherwise include, a set of laminated layers. Each laminated layer of the set of laminated layers can include two segments 812a-b. The segments 812 can be separated by a gap 814. Each laminated layer can include other suitable amounts of segments 812 and gaps 814 for forming the stacked laminated magnetic core 800. Additionally or alternatively, each laminated layer of the laminated layers can be spatially rotated around a central axis of the stacked laminated magnetic core 800. For example, as illustrated in FIG. 8, a first layer 816a is rotated approximately 45 degrees with respect to a second layer 816b, but other angular offsets can be used. Accordingly, adjacent laminated layers can have offsets relative to one another in the stacked laminated magnetic core 800. In some examples, as a result of layering the laminated layers with offsets, the stacked laminated magnetic core 800 can be a star shape as illustrated in FIG. 9.

FIG. 9 is a perspective view of the stacked laminated magnetic core 800 according to some examples of the present disclosure. As illustrated, the stacked laminated magnetic core 800 is star-shaped, but the stacked laminated magnetic core 800 can subsequently be milled or otherwise refined into a cylindrical shape, or bobbin shape, around which a wire can be wrapped to form the wireless coupler 109. The stacked laminated magnetic core 800 can be characterized by a first end 908 and by a second end 910. The central axis can extend from the first end 908 of the stacked laminated magnetic core 800 to the second end 910 of the stacked laminated magnetic core 800, for example along a longitudinal length of the wireless coupler 109.

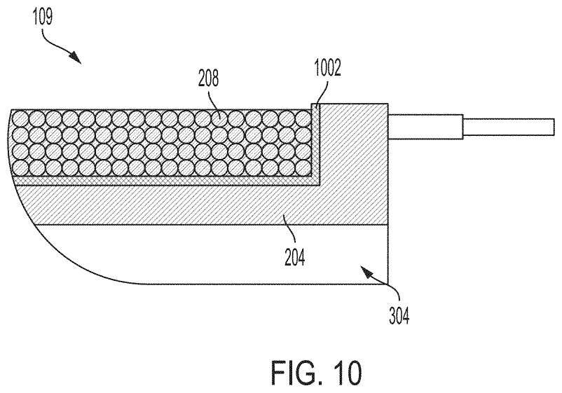

FIG. 10 is a close-up cross-sectional side view of a portion of a wireless coupler 109 that includes an insulation layer 1002 according to some examples of the present disclosure. In some examples, the wireless coupler 109 can be the first wireless coupler 230 and can include the first magnetic core 204 and the first wire 208, where the first magnetic core 204 can have an interior region 304 that may be hollow or filled with any suitable material. The insulation layer 1002 can be positioned between the first magnetic core 204 and the first wire 208. The insulation layer 1002 can insulate the first magnetic core 204 from the first wire 208. For example, the insulation layer 1002 can include insulating materials such as insulating polymers, rubber-like material, and the like, and the insulation layer 1002 can prevent electrical current from flowing between the first magnetic core 204 and the first wire 208. The insulation layer 1002 can be coupled to the first magnetic core 204 in the wireless coupler 109.

While the insulation layer 1002 is described with respect to the first wireless coupler 230, the first magnetic core 204, and the first wire 208, it will be appreciated that the insulation layer 1002 can additionally or alternatively be included in the second wireless coupler 232 to provide insulation between the second magnetic core 206 and the second wire 210.

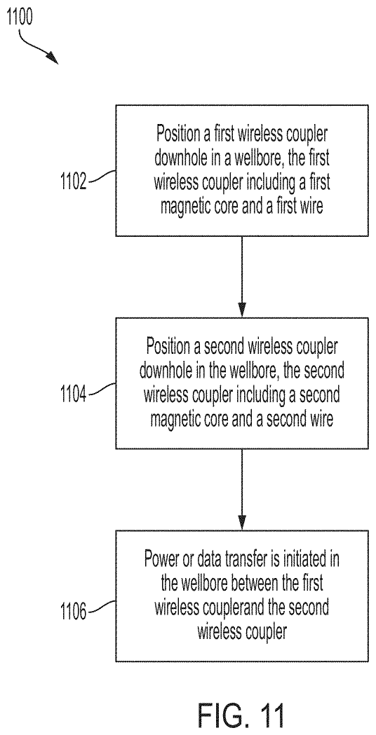

FIG. 11 is a flow chart of a process 1100 for using wireless couplers 109 in a wellbore 118 according to some examples of the present disclosure. Other examples of flow charts may involve more steps, fewer steps, different steps, or a different combination of steps than is shown in FIG. 11. The below steps are described with reference to the components of FIGS. 1-10 described above.

At block 1102, a first wireless coupler is positioned downhole in a wellbore 118. The first wireless coupler can include a first magnetic core 204 and a first wire 208. The first wireless coupler can be coupled to a first mandrel, a first well tool, or other suitable component. In some examples, the first wireless coupler can be positioned downhole in the wellbore 118 using a first mandrel. For example, the first wireless coupler can be positioned on or otherwise mechanically coupled to the first mandrel, and the first mandrel can be positioned downhole in the wellbore 118.

At block 1104, a second wireless coupler is positioned downhole in the wellbore 118. The second wireless coupler can include a second magnetic core 206 and a second wire 210. In some examples, the second wireless coupler can be positioned proximate to the first wireless coupler such that the first wire 208 and second wire 210 are coaxial with respect to one another. The second wireless coupler can be coupled to a second mandrel, a second well tool, or other suitable component for receiving the second wireless coupler. In some examples, the second wireless coupler can be positioned downhole in the wellbore 118 using the second mandrel. For example, the second wireless coupler can be positioned on or otherwise mechanically coupled to the second mandrel, and the second mandrel can be positioned downhole in the wellbore 118.

The first wireless coupler and the second wireless coupler can be positioned in the wellbore 118 separately or otherwise at different times. For example, the first wireless coupler can be positioned in the wellbore 118, and, in response to the first wireless coupler being positioned in the wellbore 118, the second wireless coupler can subsequently be positioned in the wellbore 118. Alternatively, the first wireless coupler and the second wireless coupler can be positioned on a common well tool and can be synchronously positioned in the wellbore 118.

At block 1106, power or data transfer is initiated in the wellbore 118 between the first wireless coupler and the second wireless coupler. The power and data transfer can be initiated to support or otherwise facilitate wellbore operations, such as drilling operations, completion operations, production operations, and the like. The power and data transfer can be initiated by a well operator or a device at the surface of the wellbore 118, remote from the wellbore 118, or at other suitable initiation locations.

In some examples, data can be transferred between the first wireless coupler to the second wireless coupler. The first wireless coupler can include a transmitter, and the second wireless coupler can include a receiver. In other examples, the first wireless coupler can additionally or alternatively include the receiver, the second wireless coupler can additionally or alternatively include the transmitter, or a combination thereof. In response to initiating the data transfer, the transmitter can transmit data to the receiver. The data can relate to the wellbore 118. For example, the data can include information about drilling conditions and completion conditions such as pressure, fluid flow, and the like. The receiver can receive the data, and, in some examples, the receiver can transmit or otherwise share the data with a computing device 140 that can be communicatively coupled to the first wireless coupler, the second wireless coupler, or a combination thereof.

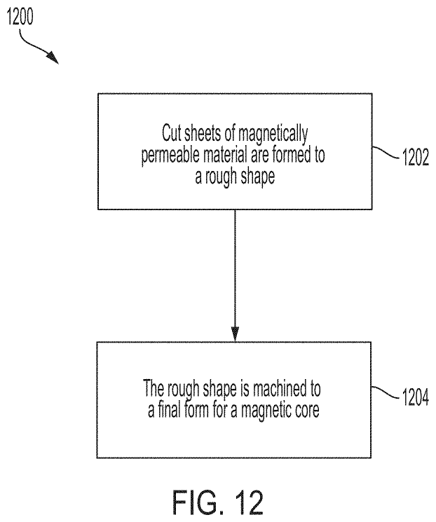

FIG. 12 is a flow chart of a process 1200 for forming a magnetic core using sheets of magnetically permeable material according to some examples of the present disclosure. At block 1202, cut sheets of magnetically permeable material are formed to a rough shape. Cut sheets of magnetically permeable material, which can include annealed silicon steel sheets or other suitable materials, can be used to form the magnetic core. In some examples, the cut sheets can be low-cost and can be easily accessed. In some examples, the cut sheets can include layers of steel and fiber coupled together. In some examples, the cut sheets can be stacked, clamped, or cast to a rough shape in a vacuum-cast process. Alternatively, the cut sheets can be stamped or cut to a rough shape and arranged in a radial pattern in a mold. The resulting arrangement can include fibers between stamped steel. The sheets can be oriented so that the direction of lamination is parallel to a longitudinal axis of the wireless coupler that will contain the magnetic core or perpendicular to the longitudinal axis.

At block 1204, the rough shape is machined to a final shape for the magnetic core. The rough shape can be machined to a final form by boring, milling, turning, a combination thereof, or by other suitable machining techniques. The resulting magnetic core can be free from patches of surface conductivity in a tangential direction. The shape of the magnetic core can improve power efficiency compared to other designs. In some examples, the cut sheets of magnetically permeable material can be stacked in a radial plane of a finished bobbin. The cut sheets can be split in order to prevent a continuous ring from forming. To improve mechanical stability, the split can be moved or rotated for each layer in a stacked arrangement.

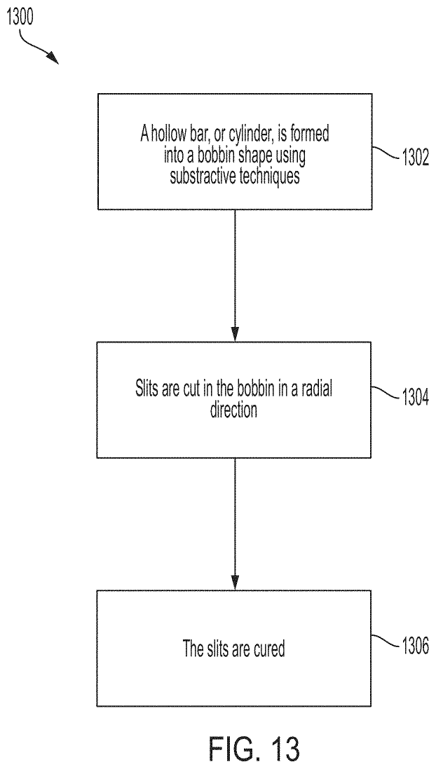

FIG. 13 shows a flow chart of a process 1300 for forming a magnetic core using hollow bars according to some examples of the present disclosure. At block 1302, a hollow bar, or cylinder, is formed into a bobbin shape using subtractive techniques. The cylinder can be formed into a bobbin shape using subtractive processes such as turning and milling.

At block 1304, slits are cut into the bobbin in a radial direction. Slits can be cut in a radial direction in the bobbin from an outer diameter of the bobbin to an inner diameter of the bobbin (e.g., the finished bobbin). In some examples, the slits can be cut using a wire electrical discharge machine for making the slits straight and narrow. The slits can be filled with resin in a vacuum cast or other suitable process. At block 1306, the slits are cured. The slits may be machined or turned before curing. In some examples, fins of the slits can be disconnected from each other.

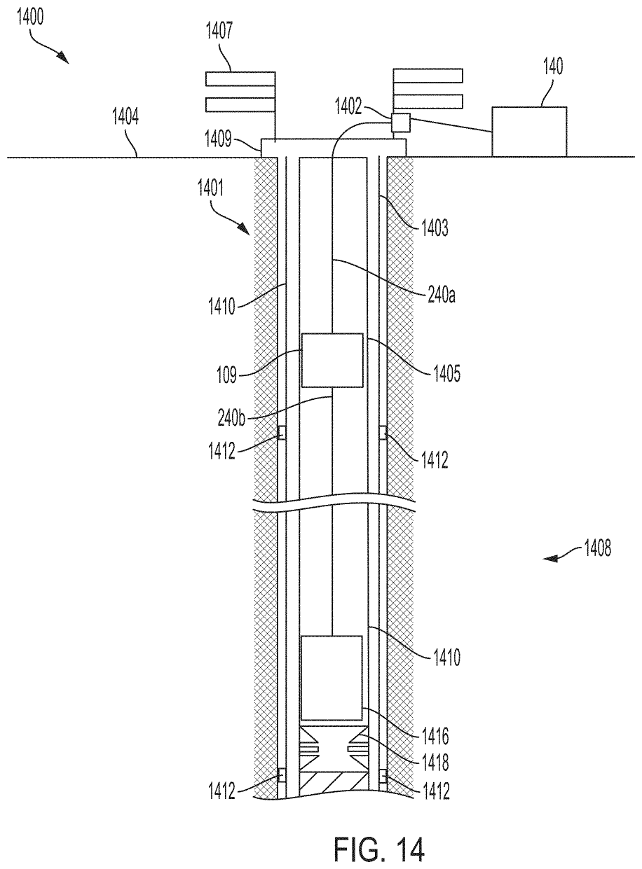

FIG. 14 shows a completion stage of a well 1400 that includes wireless couplers 109 according to some examples of the present disclosure. As illustrated, FIG. 14 depicts a completion stage of the well 1400 in which drilling operations of the well 1400 have been performed, and the well 1400 is being prepared for stimulation, production, or a combination thereof.

The well 1400 can include a wellbore 1401 with a casing string 1403 extending from the surface 1404 through the wellbore 1401. A blowout preventer 1407 can be positioned above a wellhead 1409 at the surface 1404. The wellbore 1401 can extend through various earth strata and may have a substantially vertical section 1408. In some examples, the wellbore 1401 can additionally include a substantially horizontal section. The casing string 1403 may include multiple casing tubes coupled together end-to-end by casing collars 1412. The substantially vertical section 1408 may extend through a hydrocarbon bearing subterranean formation.

The well 1400 can include a well tool 1410, which in this example may be a completion string. The well tool 1410 can include other downhole components internally or externally to an outer housing 1410 of the well tool 1410. Examples of the downhole components can include other well tools 1416, well plugs 1418, and the like, for performing one or more completion operations. In some examples, the well tool 1400 includes the wireless couplers 109. The wireless couplers 109 can be coupled to any suitable components of the well tool 1410 for transmitting data or power to said components.

At the surface of the well 1400 can be other components, such as the computing device 140 or other suitable surface devices, which can be positioned uphole with respect to the wireless couplers 109 and may be coupled to the wireless couplers 109. The surface devices can include a power source 1402 such as a battery, a generator, or other suitable power sources that may be coupled to the wireless couplers 109.

The wireless couplers 109 can be coupled to the components using cables 240a-b. For example, the wireless couplers 109 can include the first wireless coupler 230 and the second wireless coupler 232. The first wireless coupler 230 can be coupled to the computing device 140 and/or the power source 1402 using the first cable 240a, and the second wireless coupler 232 can be coupled to the downhole components using the second cable 240b. The wireless couplers 109 can transfer power and data between downhole locations and uphole locations of the well 1400 via the cables 240a-b.

The power source 1402 can be a battery or a generator positioned at the surface 1404 of the well 1400 for transferring power into the well 1400. The power source 1402 can be in electrical connection with the wireless couplers 109 and/or the computing device 140. The power source 1402 can transmit power to one or more subparts, subsystems, or components positioned in the well 1400. For example, the power source 1400 can transmit power to the first wireless coupler 230 on a first subpart of the completion string 1405. The first wireless coupler 230 can wirelessly transfer the power to the second wireless coupler 232 on a second subpart of the completion string 1405. Using this process, power can be conveyed to the second subpart of the completion string 1405 for performing one or more operations downhole involving the well tools 1414 or other suitable components with respect to the well 1400.

In some aspects, devices, well tools, and methods for laminated magnetic cores for a wireless coupler positionable in a wellbore are provided according to one or more of the following examples.

As used below, any reference to a series of examples is to be understood as a reference to each of those examples disjunctively (e.g., “Examples 1-4” is to be understood as “Examples 1, 2, 3, or 4”).

Example 1 is a system comprising: a first wireless coupler having a first laminated core wrapped around a tubular and a first wire wrapped around the first laminated core; and a second wireless coupler including a second wire positionable concentrically or eccentrically around and at a distance from the first wire for facilitating wireless power transfer between the first wireless coupler and the second wireless coupler.

Example 2 is the system of example 1, further comprising a transmitter coupled to the first wire and a receiver coupled to the second wire, the transmitter being configured to transmit data to the receiver via a wireless coupling between the first wireless coupler and the second wireless coupler.

Example 3 is the system of any of examples 1-2, wherein the second wireless coupler includes a second laminated core wrapped around the second wire.

Example 4 is the system of any of examples 1-3, wherein the first wireless coupler and the second wireless coupler are positioned on well tools for transmitting power and data between the well tools.

Example 5 is the system of any of examples 1-4, wherein the first wireless coupler includes a first shield enclosing the first wire and the first laminated core, and wherein the second wireless coupler includes a second shield enclosing the second wire.

Example 6 is the system of any of examples 1-5, wherein the first laminated core includes a plurality of laminated layers, the plurality of laminated layers being held together by an adhesive or a mechanical fastener.

Example 7 is the system of example 6, wherein the plurality of laminated layers have a direction of lamination that is parallel to a longitudinal axis of the first wireless coupler.

Example 8 is the system of example 6, wherein the plurality of laminated layers have a direction of lamination that is perpendicular to a longitudinal axis of the first wireless coupler such that a common central axis of the plurality of laminated layers extends perpendicularly to faces of the plurality of laminated layers and along a longitudinal length of the first wireless coupler.

Example 9 is the system of example 8, wherein each layer of the plurality of laminated layers includes two segments separated by a gap, and wherein each layer of the plurality of laminated layers is spatially rotated around the common central axis so as to have an offset relative to at least one adjacent layer in the plurality of laminated layers.

Example 10 is a method comprising: positioning a first wireless coupler downhole in a wellbore, the first wireless coupler having a first laminated core wrapped around a tubular and a first wire wrapped around the first laminated core; positioning a second wireless coupler downhole in the wellbore, the second wireless coupler having a second wire positioned coaxially around and at a distance from the first wire; and initiating power transfer between the first wireless coupler and the second wireless coupler.

Example 11 is the method of example 10, further comprising initiating data transfer from a transmitter coupled to the first wireless coupler to a receiver coupled to the second wireless coupler.

Example 12 is the method of any of examples 10-11, wherein the second wireless coupler includes a second laminated core wrapped around the second wire.

Example 13 is the method of any of examples 10-12, wherein the first wireless coupler and the second wireless coupler are positioned on well tools for transmitting power and data between the well tools.

Example 14 is the method of any of examples 10-13, wherein the first laminated core includes a plurality of laminated layers that have a direction of lamination that is parallel to a longitudinal axis of the first wireless coupler.

Example 15 is the method of any of examples 10-13, wherein the first laminated core includes a plurality of laminated layers that have a direction of lamination that is perpendicular to a longitudinal axis of the first wireless coupler such that a common central axis of the plurality of laminated layers extends perpendicularly to faces of the plurality of laminated layers, wherein each layer of the plurality of laminated layers includes two segments separated by a gap, and wherein each layer of the plurality of laminated layers is spatially rotated around the common central axis so as to have an offset relative to at least one adjacent layer in the plurality of laminated layers.

Example 16 is a well tool comprising: a first mandrel having a first wireless coupler that includes a first laminated core and a first wire wrapped around the first laminated core; and a second mandrel having a second wireless coupler that includes a second wire positionable coaxially around and at a distance from the first wire for facilitating wireless power transfer between the first wireless coupler and the second wireless coupler.

Example 17 is the well tool of example 16, further comprising a transmitter coupled to the first wire and a receiver coupled to the second wire, the transmitter being configured to transmit data to the receiver via a wireless coupling between the first wireless coupler and the second wireless coupler.

Example 18 is the well tool of any of examples 16-17, wherein the first mandrel and the second mandrel are separately positionable in a wellbore.

Example 19 is the well tool of any of examples 16-18, wherein the first laminated core includes a plurality of laminated layers that have a direction of lamination that is parallel to a longitudinal axis of the first wireless coupler.

Example 20 is the well tool of any of examples 16-18, wherein the first laminated core includes a plurality of laminated layers that have a direction of lamination that is perpendicular to a longitudinal axis of the first wireless coupler such that a common central axis of the plurality of laminated layers extends perpendicularly to faces of the plurality of laminated layers and along a longitudinal length of the first wireless coupler, wherein each layer of the plurality of laminated layers includes two segments separated by a gap, and wherein each layer of the plurality of laminated layers is spatially rotated around the common central axis so as to have an offset relative to at least one adjacent layer in the plurality of laminated layers.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a first wireless coupler having a first laminated core wrapped around a tubular and a first wire wrapped around the first laminated core; and
a second wireless coupler including a second wire positionable concentrically or eccentrically around and at a distance from the first wire for facilitating wireless power transfer between the first wireless coupler and the second wireless coupler.

2. The system of claim 1, further comprising a transmitter coupled to the first wire and a receiver coupled to the second wire, the transmitter being configured to transmit data to the receiver via a wireless coupling between the first wireless coupler and the second wireless coupler.

3. The system of claim 1, wherein the second wireless coupler includes a second laminated core wrapped around the second wire.

4. The system of claim 1, wherein the first wireless coupler and the second wireless coupler are positioned on well tools for transmitting power and data between the well tools.

5. The system of claim 1, wherein the first wireless coupler includes a first shield enclosing the first wire and the first laminated core, and wherein the second wireless coupler includes a second shield enclosing the second wire.

6. The system of claim 1, wherein the first laminated core includes a plurality of laminated layers, the plurality of laminated layers being held together by an adhesive or a mechanical fastener.

7. The system of claim 6, wherein the plurality of laminated layers have a direction of lamination that is parallel to a longitudinal axis of the first wireless coupler.

8. The system of claim 6, wherein the plurality of laminated layers have a direction of lamination that is perpendicular to a longitudinal axis of the first wireless coupler such that a common central axis of the plurality of laminated layers extends perpendicularly to faces of the plurality of laminated layers and along a longitudinal length of the first wireless coupler.

9. The system of claim 8, wherein each layer of the plurality of laminated layers includes two segments separated by a gap, and wherein each layer of the plurality of laminated layers is spatially rotated around the common central axis so as to have an offset relative to at least one adjacent layer in the plurality of laminated layers.

10. A method comprising:
positioning a first wireless coupler downhole in a wellbore, the first wireless coupler having a first laminated core wrapped around a tubular and a first wire wrapped around the first laminated core;
positioning a second wireless coupler downhole in the wellbore, the second wireless coupler having a second wire positioned coaxially around and at a distance from the first wire; and
initiating power transfer between the first wireless coupler and the second wireless coupler.

11. The method of claim 10, further comprising initiating data transfer from a transmitter coupled to the first wireless coupler to a receiver coupled to the second wireless coupler.

12. The method of claim 10, wherein the second wireless coupler includes a second laminated core wrapped around the second wire.

13. The method of claim 10, wherein the first wireless coupler and the second wireless coupler are positioned on well tools for transmitting power and data between the well tools.

14. The method of claim 10, wherein the first laminated core includes a plurality of laminated layers that have a direction of lamination that is parallel to a longitudinal axis of the first wireless coupler.

15. The method of claim 10, wherein the first laminated core includes a plurality of laminated layers that have a direction of lamination that is perpendicular to a longitudinal axis of the first wireless coupler such that a common central axis of the plurality of laminated layers extends perpendicularly to faces of the plurality of laminated layers, wherein each layer of the plurality of laminated layers includes two segments separated by a gap, and wherein each layer of the plurality of laminated layers is spatially rotated around the common central axis so as to have an offset relative to at least one adjacent layer in the plurality of laminated layers.

16. A well tool comprising:
a first mandrel having a first wireless coupler that includes a first laminated core and a first wire wrapped around the first laminated core; and
a second mandrel having a second wireless coupler that includes a second wire positionable coaxially around and at a distance from the first wire for facilitating wireless power transfer between the first wireless coupler and the second wireless coupler.

17. The well tool of claim 16, further comprising a transmitter coupled to the first wire and a receiver coupled to the second wire, the transmitter being configured to transmit data to the receiver via a wireless coupling between the first wireless coupler and the second wireless coupler.

18. The well tool of claim 16, wherein the first mandrel and the second mandrel are separately positionable in a wellbore.

19. The well tool of claim 16, wherein the first laminated core includes a plurality of laminated layers that have a direction of lamination that is parallel to a longitudinal axis of the first wireless coupler.

20. The well tool of claim 16, wherein the first laminated core includes a plurality of laminated layers that have a direction of lamination that is perpendicular to a longitudinal axis of the first wireless coupler such that a common central axis of the plurality of laminated layers extends perpendicularly to faces of the plurality of laminated layers and along a longitudinal length of the first wireless coupler, wherein each layer of the plurality of laminated layers includes two segments separated by a gap, and wherein each layer of the plurality of laminated layers is spatially rotated around the common central axis so as to have an offset relative to at least one adjacent layer in the plurality of laminated layers.
